(19) United States
(12) Patent Application Publication
(10) Pub. No.: US 2020/0019498 A1
(43) Pub. Date: Jan. 16, 2020

(54) GENERATIONAL GARBAGE COLLECTOR

(71) Applicant: EMC IP Holding Company LLC, Hopkinton, MA (US)

(72) Inventors: Mikhail Danilov, Saint Petersburg (RU); Konstantin Buinov, Prague (CZ)

(21) Appl. No.: 16/032,287

(22) Filed: Jul. 11, 2018

(51) Int. Cl. G06F 12/02; G06F 3/06

(52) U.S. Cl. CPC G06F 12/0276; G06F 12/0261; G06F 3/0608; G06F 2212/7205; G06F 3/065; G06F 3/067; G06F 3/0652

(57) ABSTRACT

The described technology is generally directed towards generational garbage collection, in which objects copied from earlier generation chunks during garbage collection are copied into a chunk of a later generation. Chunks are associated with generation numbers, starting with an original generation number (e.g., zero). When a garbage collection cycle occurs, objects of one generation of chunks are copied into chunks with a next generation number. As a result, over garbage collection cycles, longer-lived objects get grouped together into later generation chunks. Because of the objects' longer lifetimes, such later generation chunks are not copied often during subsequent garbage collection cycles, thereby avoiding the expense of copying for many objects.

### TECHNICAL FIELD

The subject application generally relates to data storage, and, for example, to a data storage system that reclaims storage capacity by copying stored object data from existing low-capacity (underloaded) chunks into a newly created chunk and deleting the underloaded chunks, and related embodiments.

### BACKGROUND

Contemporary cloud-based data storage systems, such as Dell EMC® Elastic Cloud Storage (ECS™) service, store data in a way that ensures data protection while retaining storage efficiency. ECS™ is referred to as “elastic” storage because the data storage system is able to store arbitrary data sets having any amount of data of any size within the available physical storage capacity, without limitations enforced at the software level.

In ECS™, object data is stored in storage units referred to as chunks, with one chunk typically storing the object data of multiple objects. When storage clients delete data, sections of dead storage space result within a chunk. To reclaim this storage space ECS™ implements a copying garbage collection in which the data from two or more low-capacity (underloaded) chunks are copied to one or more new chunk in a way that assures higher capacity utilization, after which the underloaded chunks are deleted to reclaim their capacity.

While this works well, copying garbage collection is relatively inefficient. One reason is that the same object data can be copied during copying garbage collection many times.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, one or more aspects of the technology described herein are directed towards maintaining generation numbers in association with chunks stored in a data storage system. Aspects comprise detecting a group of underloaded chunks, in which each chunk of the group has a matching generation number with respect to each other chunk of the group. Described herein is accessing a destination chunk, (e.g., opening an existing chunk with a next generation number, or creating one or more new chunks for inclusion in the chunks stored in the data storage system and setting the generation number of the one or more new chunks based on adjusting the matching generation number of the group of underloaded chunks to the next generation number). Aspects comprise garbage collecting the group of underloaded chunks by copying object data from the underloaded chunks into the one or more new chunks and deleting the underloaded chunks.

Other embodiments may become apparent from the following detailed description when taken in conjunction with the drawings.

### BRIEF DESCRIPTION OF THE DRAWINGS

The technology described herein is illustrated by way of example and not limited in the accompanying figures in which like reference numerals indicate similar elements and in which:

FIG. 1 is an example block diagram representation of part of a data storage system including nodes, in which chunks of object have are associated with generation numbers used for garbage collection, according to one or more example implementations.

FIG. 2 is a representation of example chunks containing objects, according to one or more example implementations.

FIGS. 3 and 4 are example representations of garbage collecting underloaded chunks into next generation destination chunks, according to one or more example implementations.

FIG. 5 is an example representation of deleting an empty chunk as part of (or after) garbage collection, according to one or more example implementations.

FIG. 6 is an example representation of sealing or leaving open underloaded destination chunks as part of (or after) garbage collection, according to one or more example implementations.

FIG. 7 is a flow diagram representing example operations for creating a new, original chunk with an original generation number, according to one or more example implementations.

FIGS. 8 and 9 comprise a flow diagram representing example operations for generational garbage collection, according to one or more example implementations.

FIG. 10 is an example block diagram showing example logic components of a data storage system that garbage collects underloaded chunks into one or more destination chunks, according to one or more example implementations.

FIG. 11 is an example flow diagram showing example operations related to garbage collecting underloaded chunks into a newly created destination chunk, according to one or more example implementations.

FIG. 12 is an example flow diagram showing example operations related to garbage collecting underloaded chunks into one or more destination chunks, according to one or more example implementations, according to one or more example implementations.

FIG. 13 is a block diagram representing an example computing environment into which aspects of the subject matter described herein may be incorporated.

### DETAILED DESCRIPTION

Various aspects of the technology described herein are generally directed towards garbage collection that operates in part by grouping objects into chunks based on a generation number that generally corresponds to the age of the objects in the chunks. In this way, as garbage collection occurs over time, data objects with relatively longer lifetimes tend to be stored separately from data objects with relatively shorter lifetimes; as a result, the chunks that have data objects with relatively longer lifetimes are do not become underloaded very often, and thus are not garbage collected very often.

By way of example, consider a copying garbage collector that is not aware of the age of the objects that are copied during copying garbage collection, and therefore may store relatively old, long-living objects and relatively young, short-living objects together in one chunk. Because the short living objects are deleted relatively quickly, the chunk becomes underloaded relatively quickly, and is thus garbage collected, which copies the, long-living objects into a new chunk, possibly again with short-living objects. This can repeat over and over; indeed, an object can be copied up to (L/l−1) times, where L and l are a longest and a shortest object lifetime in a system, respectively. For example, if there are objects that live for one quarter (e.g., call records) and an object that lives for five years (e.g., a financial document), then the long-living object can be copied by the copying garbage collector up to nineteen times over its five-year life. Note that such a variety of lifecycles can be commonplace in a data storage system like Elastic Cloud Storage (ECS™), because ECS™ provides a single archive platform for all types of data.

Instead, by having a copying garbage collector as described herein, relatively long-living objects get grouped together over time (over garbage collection cycles). As a result, a long-living object is not copied more than (N-1) times, where N is a number of object groups with an approximately similar lifetime. In actual operations, the number of times an object is copied is normally less, because of other delays; e.g., a complete garbage collection cycle takes a relatively long time.

As will be understood, the implementation(s) described herein are non-limiting examples, and variations to the technology can be implemented. For example, in ECS™ cloud storage technology a “chunk” is a data storage unit/structure in which data objects are stored together, garbage collected and so on; however any data storage unit/structure can be used, such as in other data storage systems. As another example, as will be understood, a chunk is associated with a generation number; however it is feasible to use another mechanism to group together objects of generally the same age, e.g., generation numbers associated with the objects, and so on.

Indeed, it should be understood that any of the examples herein are non-limiting. For instance, some of the examples are based on ECS™ cloud storage technology; however virtually any storage system may benefit from the technology described herein. Thus, any of the embodiments, aspects, concepts, structures, functionalities or examples described herein are non-limiting, and the technology may be used in various ways that provide benefits and advantages in computing and data storage in general.

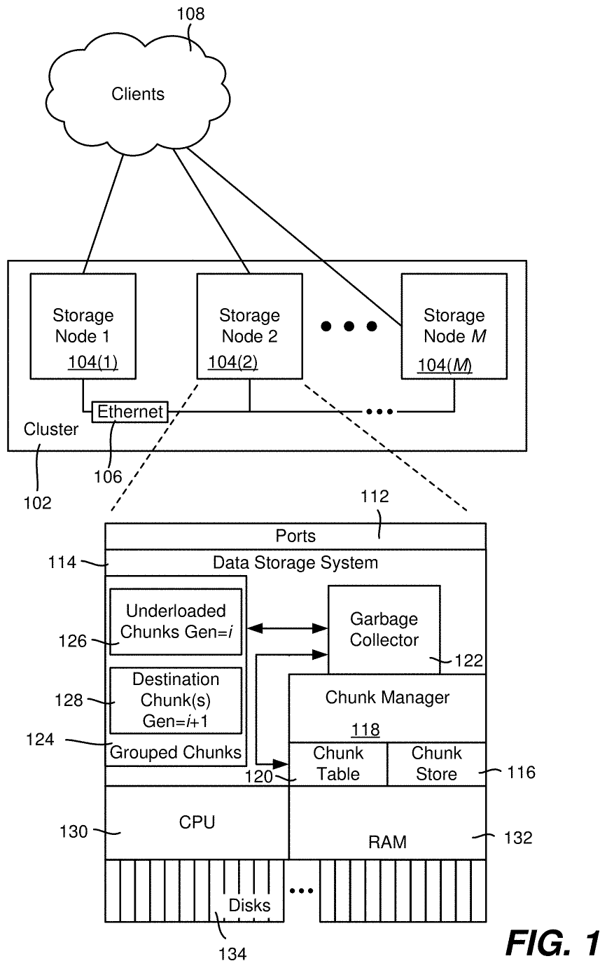

FIG. 1 shows part of a cloud data storage system such as ECS™ comprising a zone (e.g., cluster) 102 of storage nodes 104(1)-104(M), in which each node is typically a server configured primarily to serve objects in response to client requests. The nodes 104(1)-104(M) are coupled to each other via a suitable data communications link comprising interfaces and protocols, such as represented in FIG. 1 by Ethernet block 106.

Clients 108 make data system-related requests to the cluster 102, which in general is configured as one large object namespace; there may be on the order of billions of objects maintained in a cluster, for example. To this end, a node such as the node 104(2) generally comprises ports 112 by which clients connect to the cloud storage system. Example ports are provided for requests via various protocols, including but not limited to SMB (server message block), FTP (file transfer protocol), HTTP/HTTPS (hypertext transfer protocol) and NFS (Network File System); further, SSH (secure shell) allows administration-related requests, for example.

In general, and in one or more implementations, e.g., ECS™, disk space is partitioned into a set of relatively large blocks of fixed size (e.g., 128 MB) referred to as chunks; user data is generally stored in chunks, e.g., in a user data repository. Normally, one chunk contains segments of several user objects. In other words, chunks can be shared, that is, one chunk may contain segments of multiple user objects; e.g., one chunk may contain mixed segments of some number of (e.g., three) user objects.

Each node, such as the node 104(2), includes an instance of a data storage system 114 and data services; (note however that at least some data service components can be per-cluster, rather than per-node). For example, ECS™ runs a set of storage services, which together implement storage business logic. Services can maintain directory tables for keeping their metadata, which can be implemented as search trees. A blob service can maintain an object table that keeps track of objects in the data storage system 114 and generally stores their metadata, including an object's data location within a chunk. There is also a “reverse” directory table (maintained by another service) that keeps a per chunk list of objects that have their data in a particular chunk.

FIG. 1 generalizes some of the above concepts, in that the user data repository of chunks is shown as a chunk store 116, managed by a chunk manager 118. A chunk table 120 maintains metadata about chunks, including generation numbers as described herein, e.g., as one of a chunk's attributes.

Further, as described herein, a garbage collector 122 is coupled to the chunk table 120 and the chunk manager 118 to group chunks based on generation number (block 124) and then garbage collect underloaded chunks 126 of one generation (e.g., with a generation number of i) into destination chunk(s) 128 of a next generation (e.g., with a generation number of i+1).

In FIG. 1, a CPU 130 and RAM 132 are shown; note that the RAM 132 may comprise at least some non-volatile RAM. The node includes storage devices such as disks 134, comprising hard disk drives and/or solid-state drives. As is understood, any node data structure such as an object, object table, chunk table, chunk, code, and the like can be in RAM 128, on disk(s) 130 or a combination of partially in RAM, partially on disk, backed on disk, replicated to other nodes and so on. For example, the garbage collector be loaded at least partially in RAM 132, and can operate on underloaded chunks 126 and write them to the destination chunk(s) 128 at least partially in RAM 132.

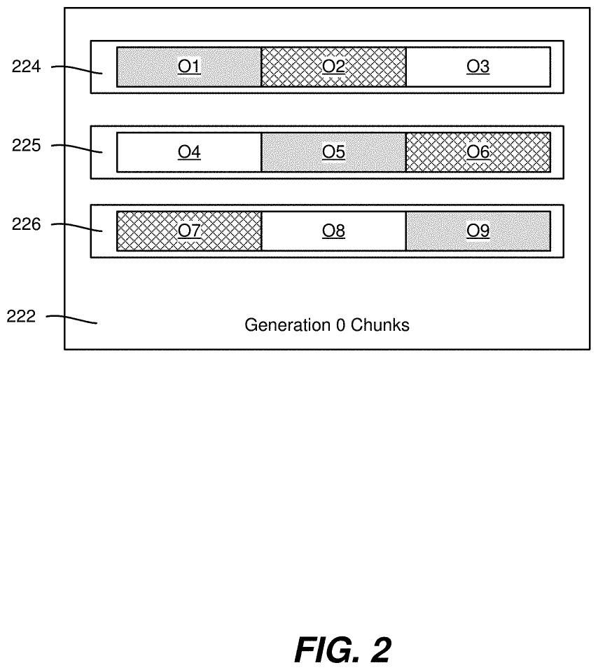

As represented in FIG. 2, chunks are associated with a generation number, and can be grouped together by that number, as represented by generation 0 chunks 222. In the example of FIG. 2, the chunks are labeled 224-226, and as can be seen, contain objects. In this simplified example the chunk 224 contains objects O1, O2 and O3, the chunk 225 contains objects O4, O5 and O6 and the chunk 226 contains objects O7, O8 and O9. Although not known to the data storage system in this example, the shaded objects O1, O5 and O9 have relatively short lives, the cross-hashed objects O2, O6 and O7 have relatively medium lives, and the white objects O3, O4 and O8 have relatively long lives. Note that the exemplified objects O1-O9 are represented as contiguous blobs of object data, however it is understood that the object data of any object can be non-contiguous within a chunk. Further, the exemplified objects O1-O9 are represented as being generally the same size, however this is only for purposes of illustration, and in actual implementations, any number of objects of any size can be within a given chunk.

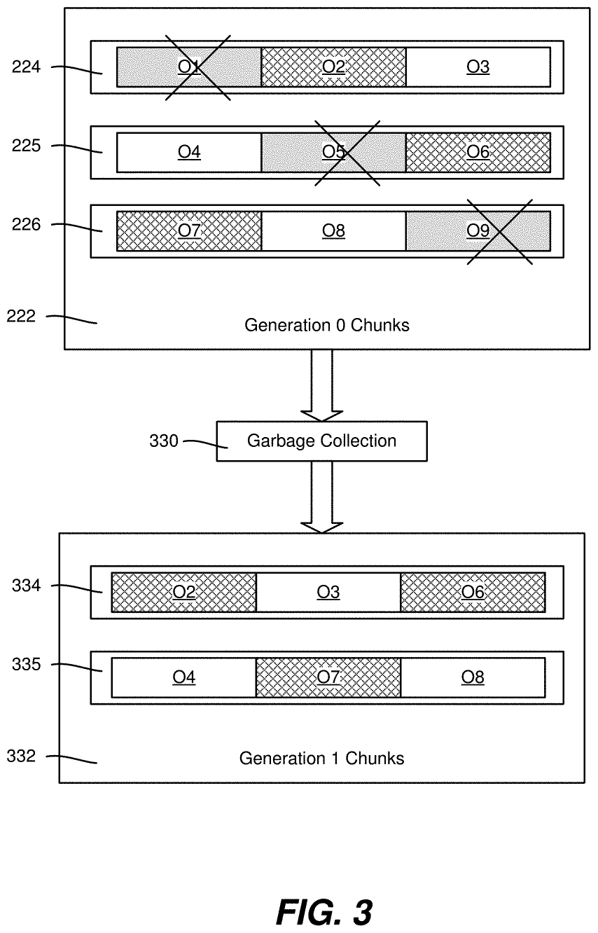

As represented in FIG. 3, over time objects get deleted, resulting in underloaded chunks. In FIG. 3, the short-lived objects O1, O5 and O9 are shown as crossed out with a large “x” to indicate that they have been deleted by a client. A garbage collection process 330 (corresponding to the garbage collector 122 of FIG. 1) accesses a next generation group 332 comprising two destination chunks 334 and 335, where “accesses” (or “access,” “accessing” and the like) refers to selecting and opening any existing chunks of the next generation (generation 1 in this example), and/or creating new chunks and associating those chunks with the next generation number (generation 1 in this example). The garbage collector 122 can work in conjunction with the chunk manager 118 as needed for this purpose.

Continuing with the example of FIG. 3, the garbage collection process 330 detects the underloaded chunks 224-226, and copies live object data from the underloaded chunks 224-226 into the destination chunks 334 and 335 of the next generation. As can be seen, the destination chunk 334 contains the copied objects O2, O3 and O6, and the destination chunk 335 contains the copied objects O4, O7 and O8. To reclaim the storage space/capacity, once copied, the generation 0 chunks of group 222, namely chunks 224-226 can be deleted. Note that deletion can, but need not, occur immediately; for example, chunks can be marked for deletion, with actual deletion performed by another process at a later time, and so on.

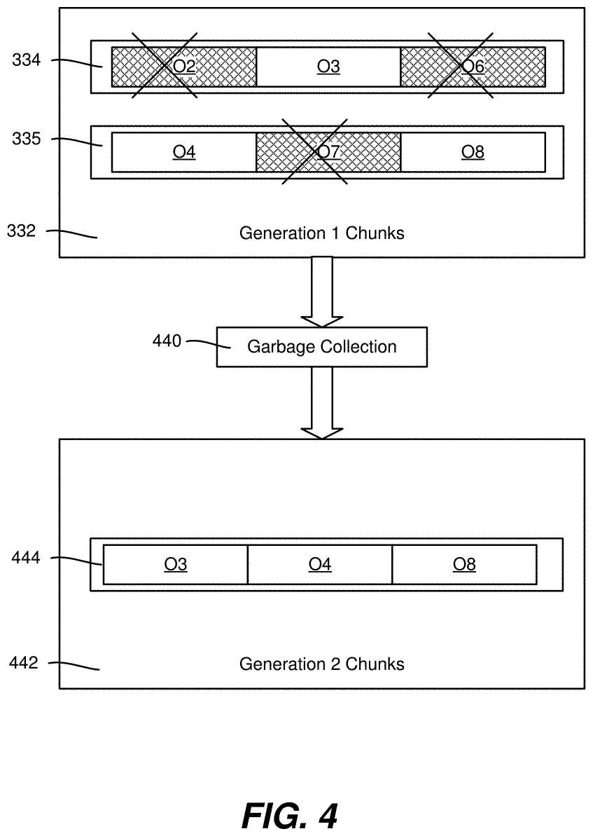

FIG. 4 shows a next generation, e.g., generation 2, resulting from another garbage collection operation (instance 440) at some later time, after the medium-lived objects O2, O6 and O7 have been deleted. The garbage collection process 440 detects the two underloaded generation 1 chunks 334 and 335 copies the live data from them to a generation 2 chunk 444. The garbage collector deletes the generation 1 chunks 334 and 335 to reclaim their storage capacity. Thus, the next garbage collection run results in a next generation group 442 (generation 2) of a chunk 444 with long-lived objects O3, O4 and O8 in the chunk.

As can be seen in FIGS. 2-4, over garbage collection iterations, the longer-lived objects get put into chunk(s) of the same generation number. In this way, longer-lived objects are not copied during garbage collection as often as shorter lived objects.

To summarize, the technology described herein uses different chunks to store objects with different lifetimes. As is understood, the lifetime of an object is counted as the number of times of copying by the garbage collector through which the object has been run.

Thus, generation 0 chunks store new objects. When a new chunk is needed to store new object(s), a new chunk is created and associated with the original generation number, which is generation 0 in one or more implementations.

Generation 1 chunks contain objects copied by the garbage once, that is, these object survived one copying by the garbage collector. Generation 2 chunks contain objects copied by the garbage collector from generation 1, that is, such objects survived two copying iterations by the garbage collector, and so on.

Thus, iterations of the garbage collector work to reduce the total number of chunks in the data storage system; (while newly created chunks increase the total number. The objects with the longest lifetime get grouped into later and later generations. Thus, the objects with the longest lifetimes start their life in generation 0, but the number of generation i chunks in a system decreases with each increment of i corresponding to each garbage collector run.

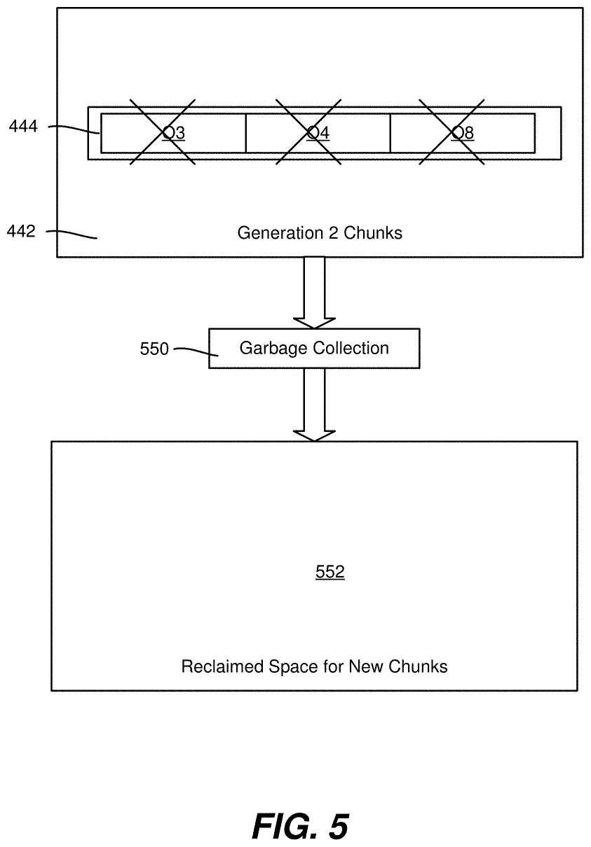

Turning to FIG. 5, after some time the objects with the long lifetimes, namely objects O3, O4 and O8 are deleted. The garbage collector detects the empty (no live object data is present) generation 2 chunk 444, deletes that chunk 444, and thereby reclaims its capacity, as represented by block 552. Note that in the example of FIG. 5, the chunk of the oldest generation (generation 2 in this example) is reclaimed without data copying. This is a high-probability scenario when there is a reasonably steady input of long-living objects. Avoiding copying is advantageous.

In one or more implementations, the generation to which a chunk belongs is maintained as a chunk attribute, which is set at chunk creation, e.g., generation 0 is the original default value. Thus, new chunks created to serve new data writes belong to generation 0. Chunks of other generations are created on demand by the garbage collector as needed. More particularly, when the garbage collector offloads a chunk from generation i, the garbage collector copies data to one of an open generation i+1 chunk. If there is no such open chunk, or the object data to be copied cannot fit in an open chunk, the garbage collector creates a new chunk of generation i+1.

Turning to another aspect, there is no way to guarantee that data from generation i−1 chunks fill up a created generation i chunk. Indeed, there is a reasonably high likelihood that at least one next generation chunk is itself underloaded. A threshold capacity value (e.g., eighty percent) can be defined for such underloaded chunks. If utilization of an underloaded chunk is below the threshold capacity, the chunk is left open so that the chunk can later store less mature data. Otherwise, an underloaded chunk is sealed with respect to any new data writes.

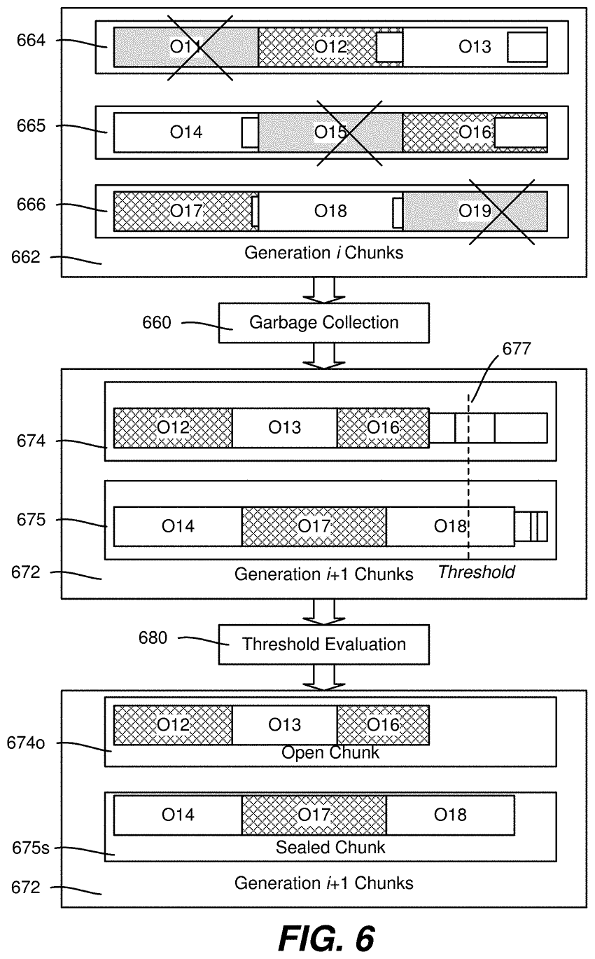

This aspect is generally represented in FIG. 6, where generation i (group 662) chunks 664-666 are garbage collected (block 660) into generation i+1 (group 672) chunks 644 and 675. Note that the objects O1-O19 do not fully fill the chunks, as represented by the blank rectangles in some of the objects. A threshold evaluation process 680, which can be part of the garbage collector 122 (FIG. 1), evaluates the resulting next generation chunks 674 and 675 against the threshold capacity value (e.g., percentage usage) as represented by the dashed line 677. Following the threshold evaluation 680, because the size of the objects in the chunk 674 is below the threshold, the chunk is left open (labeled 674o), while the chunk 675 is sealed (labeled 674s) because its size exceeds the threshold.

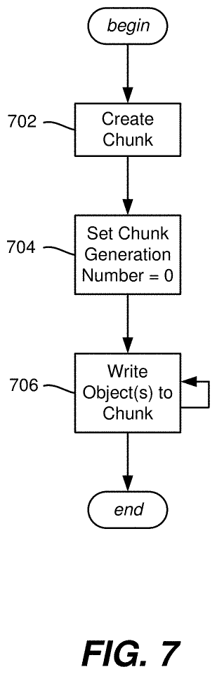

FIG. 7 shows example logic for creating a new generational chunk, as represented by operation 702. Operation 704 represents setting the generation number of the new chunk to the original value, e.g., generation 0 in one or more implementations. At this time, new objects can be written to the new chunk, as represented by operation 706.

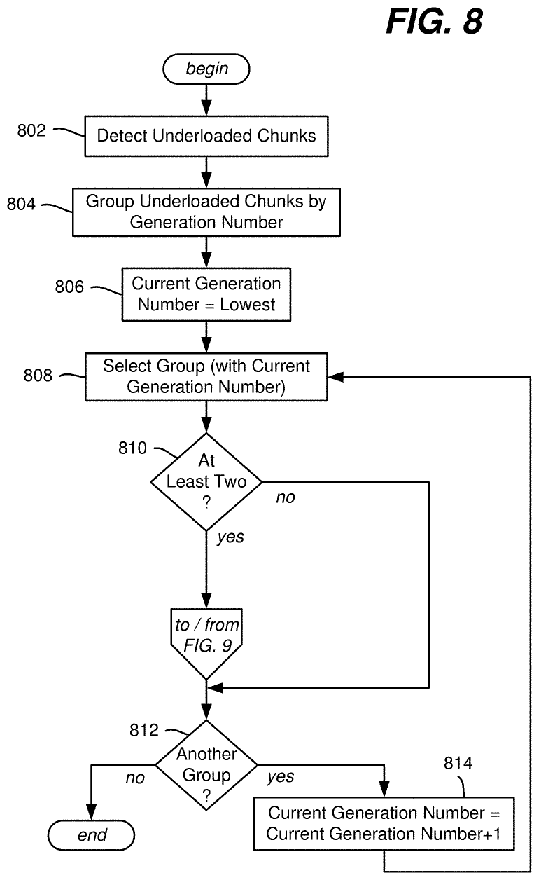

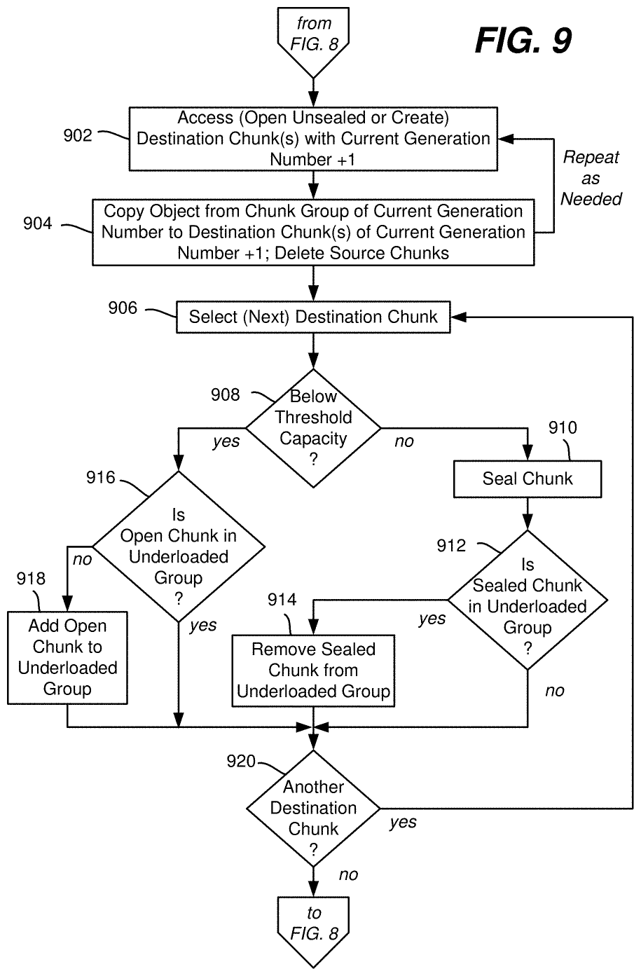

FIGS. 8 and 9 show example operations related to garbage collection, beginning at operation 802 where underloaded chunks are detected. This can be by generation number, or operation 804 can be performed to group the underloaded chunks by generation number once detected.

Operation 806 sets the current generation number to be that of the lowest group. Typically this will be zero, because garbage collection cycles take a long time. Operation 808 selects that group for garbage collection.

As can be understood, there needs to be at least two underloaded chunks in a group, otherwise copying would basically only compact a single underloaded chunk, which is not worth the expense. Also, a group can be empty, e.g., there may not be any underloaded chunks in a group. Thus, operation 810 can check for such a situation.

The operations of FIG. 9 are performed to operate the copying and deleting part of the garbage collector. Operation 902 represents accessing (opening unsealed and/or creating new) chunks of the next generation number, which in this example is the current generation number plus one. Operation 904 represents copying the object(s) from the current generation number underloaded chunk group to the destination chunk(s) in the next generation number chunk group. These operations repeat as needed until copying/deleting of the group completes.

Operation 906 represents the threshold evaluation on the destination chunk or chunks. A chunk is selected at operation 906 and evaluated with respect to the threshold capacity at operation 908. Note that every destination chunk need not be evaluated in this way, e.g., operations 902 and/or 904 can mark a chunk as not needing evaluation if the destination chunk is filled (or the evaluation/sealing or leaving open can occur at part of those operations). In any event, if a chunk is not below the capacity, the chunk is sealed at operation 910, otherwise the chunk is left open.

Note that a sealed, underloaded chunk need not be garbage collected, because such a chunk has high capacity usage. Thus, a previously open chunk may be in the detected generational group of underloaded chunks for the next generation, but following copying, may no longer be considered sufficiently underloaded to merit garbage collection. Operations 912 and 914 remove such a sealed, underloaded chunk from its generational group, if previously detected.

Similarly, an open, underloaded chunk can still be garbage collected, and thus if newly created, the open, underloaded chunk is not in the detected generational group of underloaded chunks for the next generation. Operations 916 and 918 add such an open, new underloaded chunk to its generational group

Operation 920 repeats the threshold evaluation process as needed until the next generation destination chunks are sealed or open. The process returns to FIG. 8, operation 812, which via operation 814 repeats the garbage collection on the next generation group, and so on, until the groups have been processed.

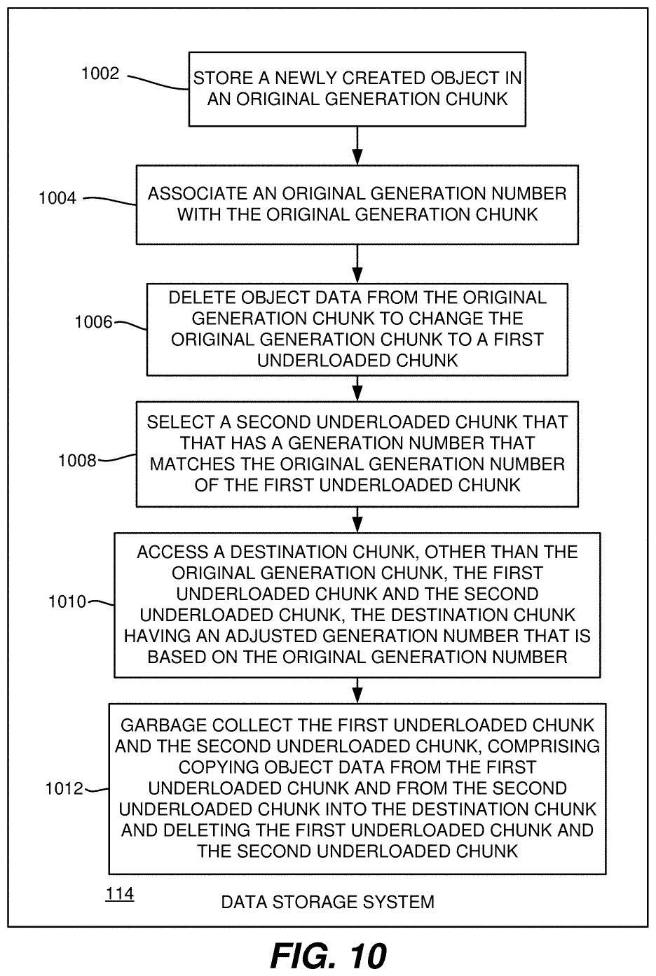

One or more aspects are represented as a data storage system 114 in FIG. 10, and include components/operations that store a newly created object in an original generation chunk (block 1002) and associate an original generation number with the original generation chunk (block 1004). The components/operations delete object data from the original generation chunk to change the original generation chunk to a first underloaded chunk (block 1006) and select a second underloaded chunk that that has a generation number that matches the original generation number of the first underloaded chunk (block 1008). The components/operations access a destination chunk, other than the original generation chunk, the first underloaded chunk and the second underloaded chunk, the destination chunk having an adjusted generation number that is based on the original generation number (block 1010); and garbage collect the first underloaded chunk and the second underloaded chunk, comprising copying object data from the first underloaded chunk and from the second underloaded chunk into the destination chunk and deleting the first underloaded chunk and the second underloaded chunk (block 1012).

The original generation number can be zero, and the adjusted generation number can be one.

The data storage system can be further configured to maintain first chunk metadata that associates the original generation number with the original generation chunk and to maintain second chunk metadata that associates the adjusted generation number with the destination chunk.

The destination chunk can be a first destination chunk, and the data storage system can be further configured to delete an object from the first destination chunk to change the first destination chunk to a third underloaded chunk, select a fourth underloaded chunk that has a generation number that matches the adjusted generation number of the third underloaded chunk, access a second destination chunk with a further adjusted generation number that is based on the adjusted generation number, and garbage collect the third underloaded chunk and the fourth underloaded chunk by copying object data from the third underloaded chunk and from the fourth underloaded chunk into the second destination chunk and deleting the third underloaded chunk and the fourth underloaded chunk. The further adjusted generation number that is based on the adjusted generation number can be obtained by incrementing the adjusted generation number to the further adjusted generation number.

The data storage system can be further configured to detect an empty underloaded chunk from which all object data has been deleted, and garbage collect the empty underloaded chunk by deleting the empty underloaded chunk.

The data storage system can be further configured to evaluate the second destination chunk with respect to a threshold capacity value, and, in response to the second destination chunk being determined to be below the threshold capacity value, leave the second destination chunk open for storing additional object data, and in response to the second new chunk being determined not to be below the threshold capacity value, seal the second destination chunk as a sealed underloaded chunk.

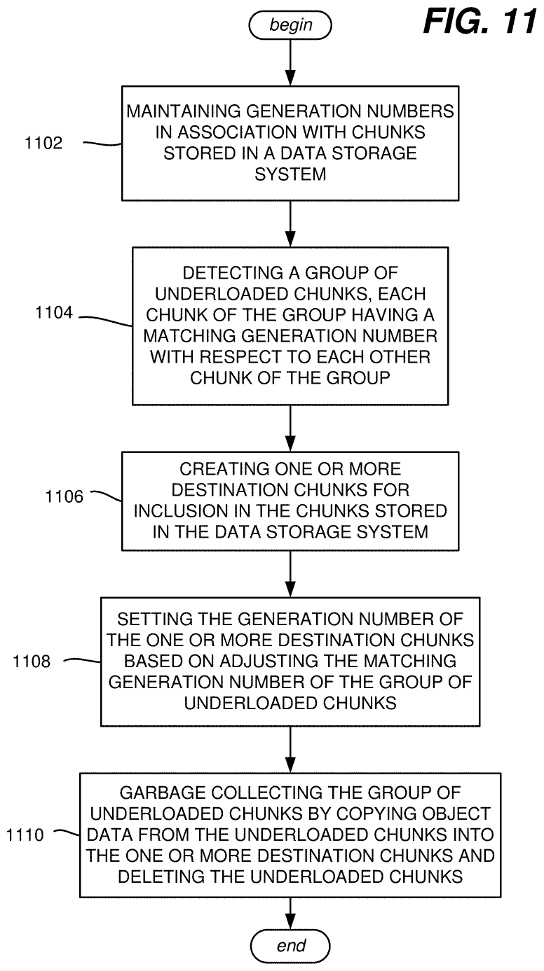

One or more aspects, generally exemplified in FIG. 11, can comprise operations, e.g., of a method. Operation 1102 represents maintaining, by a system comprising a processor, generation numbers in association with chunks stored in a data storage system. Operation 1104 represents detecting a group of underloaded chunks, each chunk of the group having a matching generation number with respect to each other chunk of the group. Operation 1106 represents creating one or more destination chunks for inclusion in the chunks stored in the data storage system. Operation 1108 represents setting the generation number of the one or more destination chunks based on adjusting the matching generation number of the group of underloaded chunks. Operation 1110 represents garbage collecting the group of underloaded chunks by copying object data from the underloaded chunks into the one or more destination chunks and deleting the underloaded chunks.

Maintaining the generation numbers in association with the chunks can comprise maintaining respective generation numbers for the chunks in respective metadata associated with the chunks. Maintaining the generation numbers in association with the chunks can comprise maintaining respective generation numbers in respective attributes associated with the chunks.

Aspects can comprise deleting object data from a chunk to obtain an underloaded chunk.

Setting the generation number of the one or more destination chunks based on the generation number of the group of underloaded chunks can comprise incrementing the matching generation number of the group of underloaded chunks.

Other aspects can comprise obtaining newly created object data to store, and storing the newly created object data as part of a chunk associated with a generation number of zero. Still other aspects can comprise detecting an empty underloaded chunk from which all object data has been deleted, and garbage collecting the empty underloaded chunk by deleting the empty underloaded chunk.

Aspects can comprise evaluating a chunk with respect to a threshold capacity value, and in response to the chunk being determined to be below the threshold capacity value, leaving the chunk open for storing additional object data relative to stored object data in the chunk, and in response to the chunk being determined not to be below the threshold capacity value, sealing the chunk as a sealed underloaded chunk.

Other aspects can comprise determining that a destination chunk of the one or more destination chunks is above a threshold capacity value, sealing the new chunk as a sealed underloaded chunk, and garbage collecting the sealed underloaded chunk.

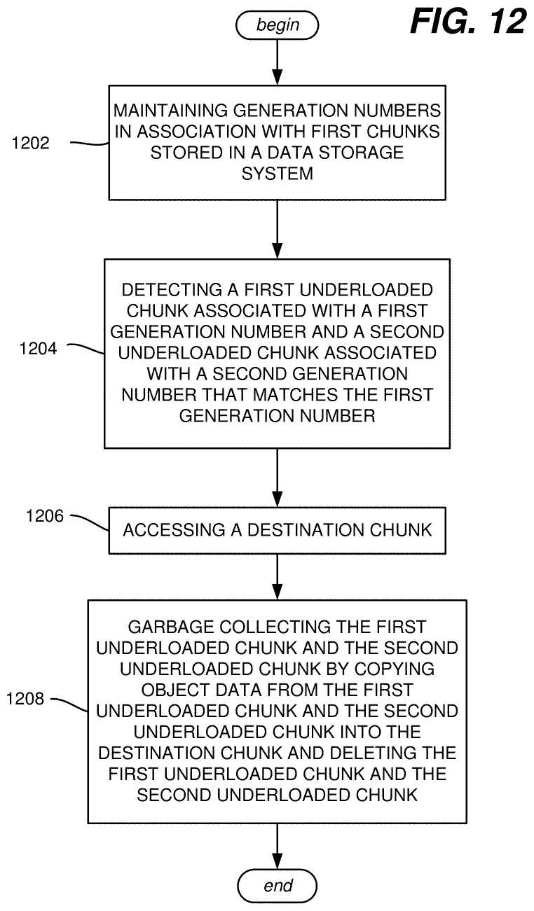

One or more aspects, such as implemented in a machine-readable storage medium, comprising executable instructions that, when executed by a processor, facilitate performance of operations, can be directed towards operations exemplified in FIG. 12. Example operation 1202 represents maintaining generation numbers in association with first chunks stored in a data storage system. Example operation 1204 represents detecting a first underloaded chunk associated with a first generation number and a second underloaded chunk associated with a second generation number that matches the first generation number. Example operation 1206 represents accessing a destination chunk. Example operation 1208 represents garbage collecting the first underloaded chunk and the second underloaded chunk by copying object data from the first underloaded chunk and the second underloaded chunk into the destination chunk and deleting the first underloaded chunk and the second underloaded chunk.

Accessing the destination chunk can comprise creating the destination chunk, and wherein the operations further comprise increasing the first generation number into a third generation number and maintaining the third generation number in association with the destination chunk. Accessing the destination chunk can comprise selecting an existing chunk as the destination chunk, wherein the existing chunk has a next generation number relative to the first generation number.

The destination chunk can be a first destination chunk, and the operations can further comprise deleting an object from the first destination chunk to change the first destination chunk to a third underloaded chunk, detecting a fourth underloaded chunk associated with a fourth generation number that matches the third generation number, creating a second destination chunk, increasing the third generation number into a fourth generation number and maintaining the fourth generation number in association with the second destination chunk, and garbage collecting the third underloaded chunk and the fourth underloaded chunk comprising copying object data from the third underloaded chunk and the fourth underloaded chunk into the second destination chunk and deleting the third underloaded chunk and the fourth underloaded chunk.

As can be seen, the technology described herein for garbage collection method is practical to implement. By using generational groups of chunks, objects with longer lives get grouped together, whereby they are less frequently copied during garbage collection. The technology thus helps to reclaim storage capacity, yet does so efficiently, producing less undesirable disk and network traffic relative to non-generational garbage collection.

### EXAMPLE COMPUTING DEVICE

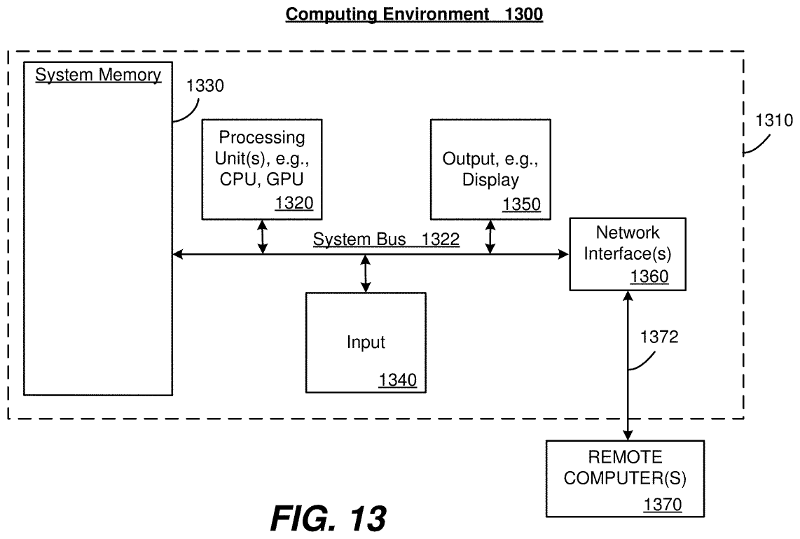

The techniques described herein can be applied to any device or set of devices (machines) capable of running programs and processes. It can be understood, therefore, that servers including physical and/or virtual machines, personal computers, laptops, handheld, portable and other computing devices and computing objects of all kinds including cell phones, tablet/slate computers, gaming/entertainment consoles and the like are contemplated for use in connection with various implementations including those exemplified herein. Accordingly, the general purpose computing mechanism described below with reference to FIG. 13 is but one example of a computing device.

Implementations can partly be implemented via an operating system, for use by a developer of services for a device or object, and/or included within application software that operates to perform one or more functional aspects of the various implementations described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 13 thus illustrates an example of a suitable computing system environment 1300 in which one or aspects of the implementations described herein can be implemented, although as made clear above, the computing system environment 1300 is only one example of a suitable computing environment and is not intended to suggest any limitation as to scope of use or functionality. In addition, the computing system environment 1300 is not intended to be interpreted as having any dependency relating to any one or combination of components illustrated in the example computing system environment 1300.

With reference to FIG. 13, an example device for implementing one or more implementations includes a general purpose computing device in the form of a computer 1310. Components of computer 1310 may include, but are not limited to, a processing unit 1320, a system memory 1330, and a system bus 1322 that couples various system components including the system memory to the processing unit 1320.

Computer 1310 typically includes a variety of machine (e.g., computer) readable media and can be any available media that can be accessed by a machine such as the computer 1310. The system memory 1330 may include computer storage media in the form of volatile and/or nonvolatile memory such as read only memory (ROM) and/or random access memory (RAM), and hard drive media, optical storage media, flash media, and so forth. By way of example, and not limitation, system memory 1330 may also include an operating system, application programs, other program modules, and program data.

A user can enter commands and information into the computer 1310 through one or more input devices 1340. A monitor or other type of display device is also connected to the system bus 1322 via an interface, such as output interface 1350. In addition to a monitor, computers can also include other peripheral output devices such as speakers and a printer, which may be connected through output interface 1350.

The computer 1310 may operate in a networked or distributed environment using logical connections to one or more other remote computers, such as remote computer 1370. The remote computer 1370 may be a personal computer, a server, a router, a network PC, a peer device or other common network node, or any other remote media consumption or transmission device, and may include any or all of the elements described above relative to the computer 1310. The logical connections depicted in FIG. 13 include a network 1372, such as a local area network (LAN) or a wide area network (WAN), but may also include other networks/buses. Such networking environments are commonplace in homes, offices, enterprise-wide computer networks, intranets and the internet.

As mentioned above, while example implementations have been described in connection with various computing devices and network architectures, the underlying concepts may be applied to any network system and any computing device or system in which it is desirable to implement such technology.

Also, there are multiple ways to implement the same or similar functionality, e.g., an appropriate API, tool kit, driver code, operating system, control, standalone or downloadable software object, etc., which enables applications and services to take advantage of the techniques provided herein. Thus, implementations herein are contemplated from the standpoint of an API (or other software object), as well as from a software or hardware object that implements one or more implementations as described herein. Thus, various implementations described herein can have aspects that are wholly in hardware, partly in hardware and partly in software, as well as wholly in software.

The word “example” is used herein to mean serving as an example, instance, or illustration. For the avoidance of doubt, the subject matter disclosed herein is not limited by such examples. In addition, any aspect or design described herein as “example” is not necessarily to be construed as preferred or advantageous over other aspects or designs, nor is it meant to preclude equivalent example structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts/flow diagrams of the various figures. While for purposes of simplicity of explanation, the methodologies are shown and described as a series of blocks, it is to be understood and appreciated that the various implementations are not limited by the order of the blocks, as some blocks may occur in different orders and/or concurrently with other blocks from what is depicted and described herein. Where non-sequential, or branched, flow is illustrated via flowcharts/flow diagrams, it can be appreciated that various other branches, flow paths, and orders of the blocks, may be implemented which achieve the same or a similar result. Moreover, some illustrated blocks are optional in implementing the methodologies described herein.

### CONCLUSION

While the invention is susceptible to various modifications and alternative constructions, certain illustrated implementations thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the invention is not to be limited to any single implementation, but rather is to be construed in breadth, spirit and scope in accordance

[symbol]

What is claimed is:

1. A system, comprising:
a data storage system configured to:
store a newly created object in an original generation chunk;
associate an original generation number with the original generation chunk;
delete object data from the original generation chunk to change the original generation chunk to a first underloaded chunk;
select a second underloaded chunk that that has a generation number that matches the original generation number of the first underloaded chunk;
access a destination chunk, other than the original generation chunk, the first underloaded chunk and the second underloaded chunk, the destination chunk having an adjusted generation number that is based on the original generation number; and
garbage collect the first underloaded chunk and the second underloaded chunk, comprising copying object data from the first underloaded chunk and from the second underloaded chunk into the destination chunk and deleting the first underloaded chunk and the second underloaded chunk.

2. The system of claim 1, wherein the original generation number is zero, and wherein the adjusted generation number is one.

3. The system of claim 1, wherein the data storage system is further configured to maintain first chunk metadata that associates the original generation number with the original generation chunk and to maintain second chunk metadata that associates the adjusted generation number with the destination chunk.

4. The system of claim 1, wherein the destination chunk is a first destination chunk, and wherein the data storage system is further configured to:
delete an object from the first destination chunk to change the first destination chunk to a third underloaded chunk,
select a fourth underloaded chunk that has a generation number that matches the adjusted generation number of the third underloaded chunk,
access a second destination chunk with a further adjusted generation number that is based on the adjusted generation number, and
garbage collect the third underloaded chunk and the fourth underloaded chunk by copying object data from the third underloaded chunk and from the fourth underloaded chunk into the second destination chunk and deleting the third underloaded chunk and the fourth underloaded chunk.

5. The system of claim 1, wherein the further adjusted generation number that is based on the adjusted generation number is obtained by incrementing the adjusted generation number to the further adjusted generation number.

6. The system of claim 1, wherein the data storage system is further configured to detect an empty underloaded chunk from which all object data has been deleted, and garbage collect the empty underloaded chunk by deleting the empty underloaded chunk.

7. The system of claim 1, wherein the data storage system is further configured to
evaluate the second destination chunk with respect to a threshold capacity value,
in response to the second destination chunk being determined to be below the threshold capacity value, leave the second destination chunk open for storing additional object data, and
in response to the second new chunk being determined not to be below the threshold capacity value, seal the second destination chunk as a sealed underloaded chunk.

8. A method, comprising:
maintaining, by a system comprising a processor, generation numbers in association with chunks stored in a data storage system;
detecting a group of underloaded chunks, each chunk of the group having a matching generation number with respect to each other chunk of the group;
creating one or more destination chunks for inclusion in the chunks stored in the data storage system;
setting the generation number of the one or more destination chunks based on adjusting the matching generation number of the group of underloaded chunks; and
garbage collecting the group of underloaded chunks by copying object data from the underloaded chunks into the one or more destination chunks and deleting the underloaded chunks.

9. The method of claim 8, wherein the maintaining the generation numbers in association with the chunks comprises maintaining respective generation numbers for the chunks in respective metadata associated with the chunks.

10. The method of claim 8, wherein the maintaining the generation numbers in association with the chunks comprises maintaining respective generation numbers in respective attributes associated with the chunks.

11. The method of claim 8, further comprising deleting object data from a chunk to obtain an underloaded chunk.

12. The method of claim 8, wherein the setting the generation number of the one or more destination chunks based on the generation number of the group of underloaded chunks comprises incrementing the matching generation number of the group of underloaded chunks.

13. The method of claim 8, further comprising obtaining newly created object data to store, and storing the newly created object data as part of a chunk associated with a generation number of zero.

14. The method of claim 8, further comprising detecting an empty underloaded chunk from which all object data has been deleted, and garbage collecting the empty underloaded chunk by deleting the empty underloaded chunk.

15. The method of claim 8, further comprising evaluating a chunk with respect to a threshold capacity value, and in response to the chunk being determined to be below the threshold capacity value, leaving the chunk open for storing additional object data relative to stored object data in the chunk, and in response to the chunk being determined not to be below the threshold capacity value, sealing the chunk as a sealed underloaded chunk.

16. The method of claim 8, further comprising determining that a destination chunk of the one or more destination chunks is above a threshold capacity value, sealing the new chunk as a sealed underloaded chunk, and garbage collecting the sealed underloaded chunk.

17. A machine-readable storage medium, comprising executable instructions that, when executed by a processor, facilitate performance of operations, the operations comprising:
maintaining generation numbers in association with first chunks stored in a data storage system;
detecting a first underloaded chunk associated with a first generation number and a second underloaded chunk associated with a second generation number that matches the first generation number;
accessing a destination chunk; and
garbage collecting the first underloaded chunk and the second underloaded chunk by copying object data from the first underloaded chunk and the second underloaded chunk into the destination chunk and deleting the first underloaded chunk and the second underloaded chunk.

18. The machine-readable storage medium of claim 17, wherein the accessing the destination chunk comprises creating the destination chunk, and wherein the operations further comprise increasing the first generation number into a third generation number and maintaining the third generation number in association with the destination chunk.

19. The machine-readable storage medium of claim 17, wherein the accessing the destination chunk comprises selecting an existing chunk as the destination chunk, wherein the existing chunk has a next generation number relative to the first generation number.

20. The machine-readable storage medium of claim 17, wherein the destination chunk is a first destination chunk, and wherein the operations further comprise:
deleting an object from the first destination chunk to change the first destination chunk to a third underloaded chunk;
detecting a fourth underloaded chunk associated with a fourth generation number that matches the third generation number;
creating a second destination chunk;
increasing the third generation number into a fourth generation number and maintaining the fourth generation number in association with the second destination chunk; and
garbage collecting the third underloaded chunk and the fourth underloaded chunk comprising copying object data from the third underloaded chunk and the fourth underloaded chunk into the second destination chunk and deleting the third underloaded chunk and the fourth underloaded chunk.
